(19) United States
(12) Patent Application Publication
(10) Pub. No.: US 2023/0088619 A1
(43) Pub. Date: Mar. 23, 2023

(54) FURNITURE HINGE DEVICE CAPABLE OF IMPLEMENTING WIDE RANGE LOADING

(71) Applicant: QINGYUAN SACA PRECISION MANUFACTURING CO., LTD., Qingyuan, Guangdong (CN)

(72) Inventors: Gengxi CAI, Qingyuan, Guangdong (CN); Jihua LUO, Qingyuan, Guangdong (CN); Kaicheng LUN, Qingyuan, Guangdong (CN); Jiabo CHEN, Qingyuan, Guangdong (CN)

(21) Appl. No.: 17/908,432

(22) PCT Filed: Sep. 16, 2020
(86) PCT No.: PCT/CN2020/115437

§ 371 Date: Aug. 31, 2022

(30) Foreign Application Priority Data
May 29, 2020 (CN) 202010476035.8

(51) Int. Cl. E05F 1/10; E05D 3/06; E05D 5/02; E05F 5/08; E05F 5/02

(52) U.S. Cl. CPC E05F 1/10; E05D 3/06; E05D 5/0276; E05F 5/08; E05F 5/02; E05Y 2201/47; E05Y 2900/20

(57) ABSTRACT

A furniture hinge device capable of implementing wide range loading, comprising a housing and a fixing plate. A linkage assembly is provided between the housing and the fixing plate. A lever assembly and a power assembly are provided on the housing. The power assembly comprises a primary spring and a secondary spring. Positioning ends of the primary spring and the secondary spring are respectively mounted, from bottom to top, at a lower swinging end of the lever assembly. An adjustment assembly is provided on connection ends of the primary spring and the secondary spring. A fixing part of the adjustment assembly is fixedly mounted on a side plate of the housing. Adjustment parts of the adjustment assembly are respectively rotatably connected to the fixing part of the adjustment assembly and are connected to adjustment ends of the primary spring and the secondary spring.

### TECHNICAL FIELD

The present disclosure relates to furniture hinges, and in particular to a furniture hinge device capable of implementing wide range loading.

### BACKGROUND

A furniture hinges is commonly used for the installation and connection of cabinet and door, especially a tilt-up door hinge which generally includes a linkage assembly and a power assembly to realize the contraction and expansion of the linkage assembly. For example, Chinese Patent NO. CN1985064B discloses a tilt-up door hinge in which the original action force of the hinge is provided by a compression spring and the adjustment of the force is achieved by adjusting the distance between the action point of the spring in the adjustment device and the pivot axis to change the length of the force arm.

The above structure of the tilt-up door hinge has the following shortcomings in actual operation.

1) The adjustment method is complicated and difficult to realize.

2) The adjustment range is small and cannot adapt to cover a wide range of loads, and thus the use of the tilt-up door hinge is limited.

### SUMMARY OF THE DISCLOSURE

Aiming at the above problems existing in the related art, the present disclosure provides a furniture hinge device capable of implementing wide range loading.

According to the first aspect of the present disclosure, a furniture hinge device capable of implementing wide range loading is provided. The furniture hinge device capable of implementing wide range loading may include a housing (1), a fixing plate (2), a linkage assembly, a lever assembly, and a power assembly. The housing (1) may be configured to be mounted on a cabinet. The fixing plate (2) may be configured to be mounted on a door. The linkage assembly may be arranged between the housing (1) and the fixing plate (2). The lever assembly and the power assembly may be arranged on the housing (1) and configured to link the linkage assembly. The fixing plate (2) may be arranged on a swinging end of the linkage assembly. A positioning end of the lever assembly may be axially connected to a side plate of the housing (1). An upper swinging end of the lever assembly may be slidingly connected to a positioning end of the linkage assembly. The power assembly may include a primary spring (3) and a secondary spring (4). A positioning end of the primary spring (3) and a positioning end of the secondary spring (4) may be respectively arranged on a lower swinging end of the lever assembly from a bottom to a top. An adjustment assembly (5) configured to adjust a working length to adjust force may be arranged at a connection end of the primary spring (3) and a connection end of the secondary spring (4). A positioning part of the adjustment assembly (5) may be fixed on the side plate of the housing (1). An adjustment part of the adjustment assembly (5) may be rotatably connected to the positioning part and connected to the connection end of the primary spring (3) and the connection end of the secondary spring (4).

Typically, the adjustment assembly (5) may include an adjustment limit block (51) and an adjustment bolt (52). The adjustment limit block (51) may be arranged on the side plate of the housing (1). The adjustment bolt (52) may be rotatably connected to the adjustment limit block (51) and threaded coupled with the primary spring (3) and secondary spring (4).

Typically, the positioning end of the primary spring (3) and the positioning end of the secondary spring (4) may be fastened to the lower swinging end of the lever assembly. A clamping block (7) configured to be threaded connected to the adjusting bolt (52) may be arranged on the connection end of the primary spring (3) and the connection end of the secondary spring (4).

Typically, the clamping block (7) may be provided with two fastening blocks (8) fastened to the connection end of the primary spring (3) and the connection end of the secondary spring (4) respectively. The clamping block (7) may be threaded connected to the adjusting bolt (52).

Typically, an external side of the clamping block (7) may be provided with at least one guide block (6). The side plate of the housing (1) may be provided with at least one guide slot (9) slidingly connected to the at least one guide block (6).

Typically, the linkage assembly may include a first linkage (10), a second linkage (11), a third linkage (12), a fourth linkage (13), and a fifth linkage (14). The fixing plate (2) may be arranged on a swinging end of the first linkage (10). A connecting end of the first linkage (10) may be connected to swinging ends of the second linkage (11) and the third linkage (12) respectively. A connecting end of the second linkage (11) may be connected to a swinging end of the fourth linkage (13). A connecting end of the fourth linkage (13) may be connected to the side plate of the housing (1). A connecting end of the third linkage (12) may be connected to a swinging end of the fifth linkage (14). A connecting end of the fifth linkage (14) may be connected to the side plate of the housing (1). A swinging end of the fifth linkage (14) may be provided with a circular arc surface (141) configured to be sliding connected with the lever assembly.

Typically, the lever assembly may include a bearing (15) and a lever component (16). A corner position of the lever component (16) may be axially connected to the side plate of the housing (1). An upper swinging end of the lever component (16) may be provided with the bearing (15) slidingly connected with the fifth linkage (14) of the linkage assembly. A lower swinging end of the lever component (16) may be fastened to the primary spring (3) and the secondary spring (4) of the power assembly from the bottom to the top.

Typically, a door opening damping assembly (17) may be provided on an upper end of the side plate of the housing (1). The fifth linkage (14) of the linkage assembly may be provided with an oblique slot (142) configured to contact with or be separated from a damping rod of the door opening damping assembly (17) with swinging of the fifth linkage (14).

Typically, the linkage assembly may be provided with a door closing damping assembly (18) arranged on the second linkage (11) of the linkage assembly. A damping rod of the door closing damping assembly (18) may be configured to contact with or be separated from the fourth linkage (13) with swinging of the fixing plate (2).

The advantages of the present disclosure may include:

1) On the basis of the non-adjustable lever assembly, the adjustment of the magnitude of an action force can be achieved by adjusting the working length of the springs through the main adjustment assembly and the secondary adjustment assembly arranged at the connection ends of the primary spring and the secondary spring. The adjustment is simple and easy to be achieved.

2) With the structure of the primary spring, secondary spring and lever assembly, the distance between the installation position of the primary spring and the pivot point of the lever assembly is different from the distance between the installation position of the secondary spring and the pivot point, the load effect differs when the primary spring length and the secondary spring length are changed equally, so as to change the load capacity of the hinge, and thus the furniture hinge device is adapt to different models and can cover a wide range of loads. The furniture hinge device may have wide applicability which ensures the using effect.

3) With the structure of the door opening damping assembly and the door closing damping assembly, the hinge is effectively cushioned during use, so as to enhance the performance of the hinge and ensure the quality of product use.

### BRIEF DESCRIPTION OF THE DRAWINGS

In order to illustrate technical solutions of the embodiments of the present disclosure clearly, accompanying drawings for describing the embodiments will be introduced in brief. Obviously, the drawings in the following description are only some embodiments of the present disclosure. For the person of ordinary skill in the art, other drawings may be obtained based on the provided drawings without any creative work, wherein:

FIG. 1 is a schematic view of a furniture hinge device capable of implementing wide range loading in an open state according to an embodiment of the present disclosure;

FIG. 2 is a schematic view of the furniture hinge device capable of implementing wide range loading in a close state according to an embodiment of the present disclosure;

FIG. 3 is a schematic view of the power assembly according to an embodiment of the present disclosure;

FIG. 4 is an exploded view of the power assembly according to an embodiment of the present disclosure.

### DETAILED DESCRIPTION

The present disclosure will be described clearly and thoroughly herein by accompanying with appended figures of some embodiments. Apparently, the embodiments are only part of the present disclosure, and are not the whole disclosure. For the person of ordinary skill in the art, other embodiments may be obtained based on the provided embodiments without any creative work, and the other embodiments are also covered by the present disclosure.

The embodiments are described with reference to the accompanying drawings, in order to illustrate specific embodiments of the present disclosure that can be implemented. In the specification, it can be understood that, directional terms recited in the present disclosure, such as “top”, “bottom”, “upper”, “lower”, “front”, “rear”, “left”, “right”, “above”, “under”, and the like, only explain the relative positional relationship, motion, etc. between the various elements under a specific posture (as shown in the accompanying drawings). If the specific posture changes, the directional terms will change accordingly. Thus, the directional terms used here are only for better and more clearly describing and understanding the present disclosure, and are not intended to indicate or imply that the devices or the elements are disposed to locate at the specific directions or are structured and performed in the specific directions, which could not to be understood as limiting the present disclosure.

In addition, terms such as “first”, “second”, “third”, and the like are used herein for purposes of description, and are not intended to indicate or imply relative importance or significance or to imply the number of indicated technical features. Thus, the feature defined with “first”, “second”, “third”, and the like may include one or more of such a feature. Further, when “and/or” appears throughout the present disclosure, it means three concurrent solutions are included. For example, “A and/or B” includes solution A, or solution B, or a solution satisfying both A and B. Moreover, the embodiments and the features recited in the embodiments of the present disclosure may be combined with each other without confliction. However, the combination must base on the ability of realization by the person of ordinary skill in the art. When a combination is contradictory or cannot be realized, it should be considered that such combination does not exist and is not within the scope of protection claimed by the present disclosure.

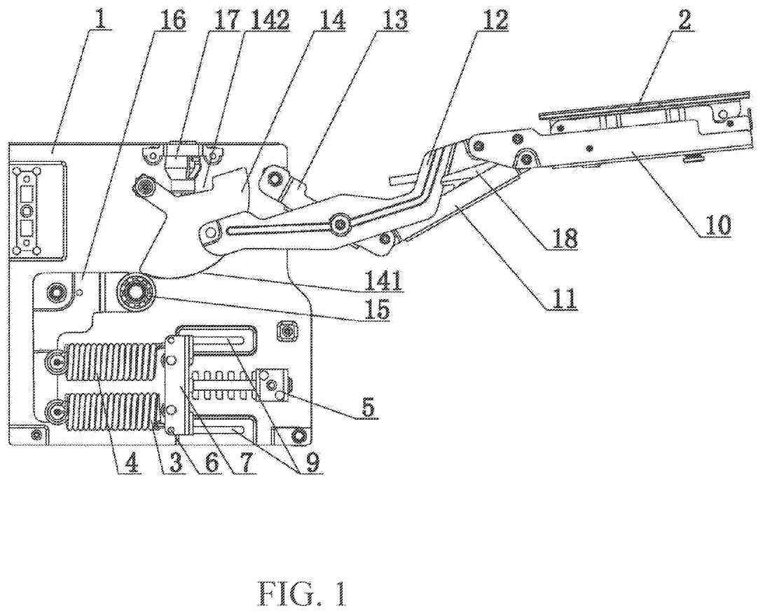

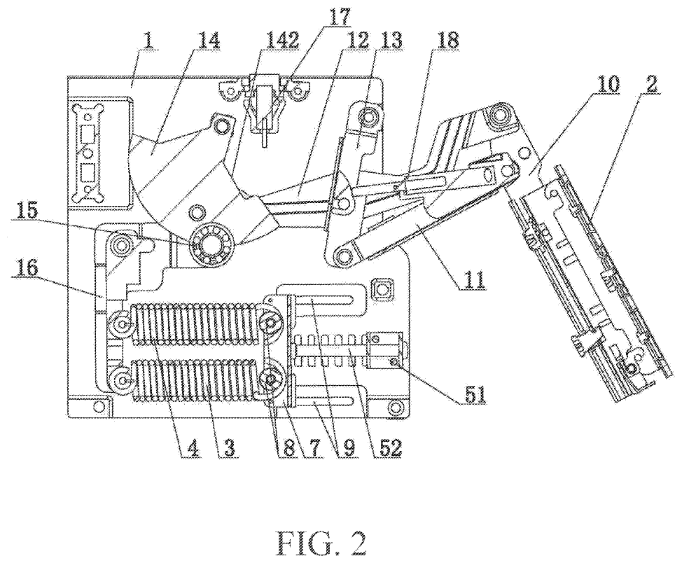

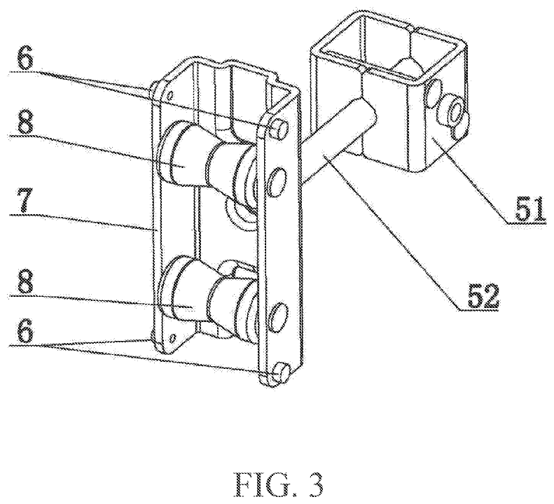

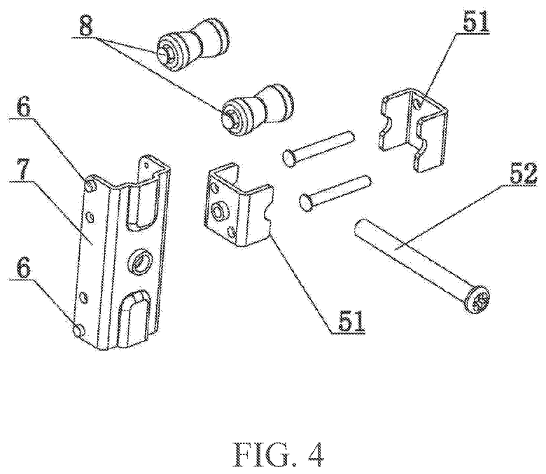

Referring to FIGS. 1-4, a furniture hinge device capable of implementing wide range loading according to the present embodiment may include a housing 1, a fixing plate 2, a linkage assembly, a lever assembly, and a power assembly. The housing 1 may be configured to be mounted on a cabinet. The fixing plate 2 may be configured to be mounted on a door. The linkage assembly may be arranged between the housing 1 and the fixing plate 2. The lever assembly and the power assembly may be arranged on the housing 1 and configured to link the linkage assembly. The fixing plate 2 may be arranged on a swinging end of the linkage assembly. A positioning end of the lever assembly may be axially connected to a side plate of the housing 1. An upper swinging end of the lever assembly may be slidingly connected to a positioning end of the linkage assembly.

Typically, the power assembly may include a primary spring 3 and a secondary spring 4. A positioning end of the primary spring 3 and a positioning end of the secondary spring 4 may be respectively arranged on a lower swinging end of the lever assembly from a bottom to a top. An adjustment assembly 5 configured to adjust a working length to adjust force may be arranged at a connection end of the primary spring 3 and a connection end of the secondary spring 4. A positioning part of the adjustment assembly 5 may be fixed on the side plate of the housing 1. An adjustment part of the adjustment assembly 5 may be rotatably connected to the positioning part and connected to the connection end of the primary spring 3 and the connection end of the secondary spring 4.

On the basis of the non-adjustable lever assembly, the adjustment of the magnitude of an action force can be achieved by adjusting the working length of the springs through the adjustment assembly 5 arranged at the connection ends of the primary spring 3 and the secondary spring 4. The adjustment is simple and easy to be achieved.

Referring to FIGS. 1-4, specifically, the adjustment assembly 5 may include an adjustment limit block 51 and an adjustment bolt 52. The adjustment limit block 51 may be arranged on the side plate of the housing 1. The adjustment bolt 52 may be rotatably connected to the adjustment limit block 51 and threaded coupled with the primary spring 3 and secondary spring 4.

Typically, the positioning end of the primary spring 3 and the positioning end of the secondary spring 4 may be fastened to the lower swinging end of the lever assembly. A clamping block 7 configured to be threaded connected to the adjusting bolt 52 may be arranged on the connection end of the primary spring 3 and the connection end of the secondary spring 4.

Typically, the clamping block 7 may be provided with two fastening blocks 8 fastened to the connection end of the primary spring 3 and the connection end of the secondary spring 4 respectively. The clamping block 7 may be threaded connected to the adjusting bolt 52.

Typically, an external side of the clamping block 7 may be provided with at least one guide block 6. The side plate of the housing 1 may be provided with at least one guide slot 9 slidingly connected to the at least one guide block 6.

The load capacity of the hinge is fixed without adjusting the length of the primary spring 3 and the secondary spring 4. The load capacity of the hinge changes when the clamping block 7 moves left and right with the rotation of the adjusting bolt 52 to change the length of the primary spring 3 and the length of the secondary spring 4. At the same time, the guide blocks 6 slides along the guide slots 9, prompting the clamping block 7 to slide directionally on the side plate of the housing 1. The structure of the hinge is solid and stable in operation. The adjustment is simple and easy to be achieved.

Typically, the linkage assembly may include a first linkage 10, a second linkage 11, a third linkage 12, a fourth linkage 13, and a fifth linkage 14. The fixing plate 2 may be arranged on a swinging end of the first linkage 10. A connecting end of the first linkage 10 may be connected to swinging ends of the second linkage 11 and the third linkage 12 respectively. A connecting end of the second linkage 11 may be connected to a swinging end of the fourth linkage 13. A connecting end of the fourth linkage 13 may be connected to the side plate of the housing 1. A connecting end of the third linkage 12 may be connected to a swinging end of the fifth linkage 14. A connecting end of the fifth linkage 14 may be connected to the side plate of the housing 1. A swinging end of the fifth linkage 14 may be provided with a circular arc surface 141 configured to be sliding connected with the lever assembly.

Typically, the linkage assembly may include a first linkage 10, a second linkage 11, a third linkage 12, a fourth linkage 13, and a fifth linkage 14. The fixing plate 2 may be arranged on a swinging end of the first linkage 10. A connecting end of the first linkage 10 may be connected to swinging ends of the second linkage 11 and the third linkage 12 respectively. A connecting end of the second linkage 11 may be connected to a swinging end of the fourth linkage 13. A connecting end of the fourth linkage 13 may be connected to the side plate of the housing 1. A connecting end of the third linkage 12 may be connected to a swinging end of the fifth linkage 14. A connecting end of the fifth linkage 14 may be connected to the side plate of the housing 1. A swinging end of the fifth linkage 14 may be provided with a circular arc surface 141 configured to be sliding connected with the lever assembly.

Typically, the lever assembly may include a bearing 15 and a lever component 16. A corner position of the lever component 16 may be axially connected to the side plate of the housing 1. An upper swinging end of the lever component 16 may be provided with the bearing 15 slidingly connected with the fifth linkage 14 of the linkage assembly. A lower swinging end of the lever component 16 may be fastened to the primary spring 3 and the secondary spring 4 of the power assembly from the bottom to the top.

The distance between the installation position of the primary spring 3 and the pivot point of the lever component 16 is different from the distance between the installation position of the secondary spring 4 and the pivot point of the lever component 16. Specifically, the secondary spring 4 has a shorter distance from the pivot point of the lever component 16 and a shorter fixed force arm, while the primary spring 3 has a longer distance from the pivot point and a longer fixed force arm. Different effects can be produced by changing the same length of the springs to achieve load adjustment of the hinge.

Referring to FIGS. 1-4, a door opening damping assembly 17 may be provided on an upper end of the side plate of the housing 1. The fifth linkage 14 of the linkage assembly may be provided with an oblique slot 142 configured to contact with or be separated from a damping rod of the door opening damping assembly 17 with swinging of the fifth linkage 14.

Typically, the linkage assembly may be provided with a door closing damping assembly 18 arranged on the second linkage 11 of the linkage assembly. A damping rod of the door closing damping assembly 18 may be configured to contact with or be separated from the fourth linkage 13 with swinging of the fixing plate 2.

While opening the door, the fixing plate 2 swings with the door to drive the first linkage 10, the second linkage 11, the third linkage 12, the fourth linkage 13, and the fifth linkage 14 to swing outward respectively. The oblique slot 142 gradually contacts the damping rod of door opening damping assembly 17 as the fifth linkage 14 swings. The damping effect of door opening damping assembly 17 slows down the outward swinging speed of the fifth linkage 14 and realizes the door opening cushion.

While closing the door, the fixing plate 2 closes toward the housing 1 under the elastic action of the primary spring 3 and the secondary spring 4. When the second linkage 11 folds toward the fourth linkage 13, the door closing damping assembly 18 swings with the second linkage 11 sand contacts with the fourth linkage 13. The damping effect of the door closing damping assembly 18 slows down the folding speed of the second linkage 11 toward the fourth linkage 13 to achieve a door closing cushion.

With the structure of the door opening damping assembly and the door closing damping assembly, the hinge is effectively cushioned during use, so as to enhance the performance of the hinge and ensure the quality of product use.

For one skilled in the art, it is clear that the present disclosure is not limited to the details of the above exemplary embodiments, and that the present disclosure can be implemented in other specific forms without deviating from the spirit or basic characteristics of the application. Therefore, at any point, the embodiments should be regarded as exemplary and unrestrictive, and the scope of the present application is defined by the appended claims, rather than the above description. Therefore, all changes within the meaning and scope of the equivalent elements of the claim or directly/indirectly utilization in other related technical fields are intended to be included in protection scope of the present disclosure. Any appended label recited in the claims shall not be regarded as a limitation to the claims.

What is claimed is:

1. A furniture hinge device capable of implementing wide range loading, comprising:
a housing, configured to be mounted on a cabinet;
a fixing plate, configured to be mounted on a door;
a linkage assembly, arranged between the housing and the fixing plate;
a lever assembly and a power assembly, arranged on the housing and configured to link the linkage assembly;
wherein the fixing plate is arranged on a swinging end of the linkage assembly, a positioning end of the lever assembly is axially connected to a side plate of the housing, an upper swinging end of the lever assembly is slidingly connected to a positioning end of the linkage assembly; and
the power assembly comprises a primary spring and a secondary spring, a positioning end of the primary spring and a positioning end of the secondary spring are respectively arranged at a lower swinging end of the lever assembly from a bottom to a top, an adjustment assembly configured to adjust a working length to adjust force is arranged at a connection end of the primary spring and a connection end of the secondary spring, a positioning part of the adjustment assembly is fixed on the side plate of the housing, and an adjustment part of the adjustment assembly is rotatably connected to the positioning part and connected to the connection end of the primary spring and the connection end of the secondary spring.

2. The furniture hinge device capable of implementing wide range loading of claim 1, wherein the adjustment assembly comprises:
an adjustment limit block, arranged on the side plate of the housing; and
an adjustment bolt, rotatably connected to the adjustment limit block and threaded coupled with the primary spring and secondary spring.

3. The furniture hinge device capable of implementing wide range loading of claim 2, wherein the positioning end of the primary spring and the positioning end of the secondary spring are fastened to the lower swinging end of the lever assembly, and a clamping block configured to be threaded connected to the adjusting bolt is arranged on the connection end of the primary spring and the connection end of the secondary spring.

4. The furniture hinge device capable of implementing wide range loading of claim 3, wherein the clamping block is provided with two fastening blocks fastened to the connection end of the primary spring and the connection end of the secondary spring respectively, and the clamping block is threaded connected to the adjusting bolt.

5. The furniture hinge device capable of implementing wide range loading of claim 3, wherein an external side of the clamping block is provided with at least one guide block, and the side plate of the housing is provided with at least one guide slot slidingly connected to the at least one guide block.

6. The furniture hinge device capable of implementing wide range loading of claim 1, wherein the linkage assembly comprises a first linkage, a second linkage, a third linkage, a fourth linkage, and a fifth linkage, the fixing plate is arranged on a swinging end of the first linkage, a connecting end of the first linkage is connected to swinging ends of the second linkage and the third linkage respectively, a connecting end of the second linkage is connected to a swinging end of the fourth linkage, a connecting end of the fourth linkage is connected to the side plate of the housing, a connecting end of the third linkage is connected to a swinging end of the fifth linkage, a connecting end of the fifth linkage is connected to the side plate of the housing, a swinging end of the fifth linkage is provided with a circular arc surface configured to be sliding connected with the lever assembly.

7. The furniture hinge device capable of implementing wide range loading of claim 1, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

8. The furniture hinge device capable of implementing wide range loading of claim 6, wherein a door opening damping assembly is provided on an upper end of the side plate of the housing, and the fifth linkage of the linkage assembly is provided with an oblique slot configured to contact with or be separated from a damping rod of the door opening damping assembly with swinging of the fifth linkage.

9. The furniture hinge device capable of implementing wide range loading of claim 1, wherein the linkage assembly is provided with a door closing damping assembly arranged on the second linkage of the linkage assembly, and a damping rod of the door closing damping assembly is configured to contact with or be separated from the fourth linkage with swinging of the fixing plate.

10. The furniture hinge device capable of implementing wide range loading of claim 2, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

11. The furniture hinge device capable of implementing wide range loading of claim 3, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

12. The furniture hinge device capable of implementing wide range loading of claim 4, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

13. The furniture hinge device capable of implementing wide range loading of claim 5, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

14. The furniture hinge device capable of implementing wide range loading of claim 6, wherein the lever assembly comprises a bearing and a lever component, a corner position of the lever component is axially connected to the side plate of the housing, an upper swinging end of the lever component is provided with the bearing slidingly connected with the fifth linkage of the linkage assembly, and a lower swinging end of the lever component is fastened to the primary spring and the secondary spring of the power assembly from the bottom to the top.

15. The furniture hinge device capable of implementing wide range loading of any one of claim 2, wherein the linkage assembly is provided with a door closing damping assembly arranged on the second linkage of the linkage assembly, and a damping rod of the door closing damping assembly is configured to contact with or be separated from the fourth linkage with swinging of the fixing plate.

16. The furniture hinge device capable of implementing wide range loading of any one of claim 3, wherein the linkage assembly is provided with a door closing damping assembly arranged on the second linkage of the linkage assembly, and a damping rod of the door closing, damping assembly is configured to contact with or be separated from the fourth linkage with swinging of the fixing plate.

17. The furniture hinge device capable of implementing wide range loading of any one of claim 4, wherein the linkage assembly is provided with a door closing damping assembly arranged on the second linkage of the linkage assembly, and a damping rod of the door closing damping assembly is configured to contact with or be separated from the fourth linkage with swinging of the fixing plate.

18. The furniture hinge device capable of implementing wide range loading of any one of claim 5, wherein the linkage assembly is provided with a door closing damping assembly arranged on the second linkage of the linkage assembly, and a damping rod of the door closing damping assembly is configured to contact with or be separated from the fourth linkage with swinging of the fixing plate.

19. The furniture hinge device capable of implementing wide range loading of any one of claim 6, wherein the linkage assembly is provided with a door closing damping assembly arranged on the second linkage of the linkage assembly, and a damping rod of the door closing damping assembly is configured to contact with or be separated from the fourth linkage with swinging of the fixing plate.
